(19) United States
(12) Patent Application Publication
(10) Pub. No.: US 2008/0092523 A1
(43) Pub. Date: Apr. 24, 2008

(54) Method For Diagnosing Cylinder-Associated Individual Catalytic Converters Of A Multicylinder Otto Cycle Internal Combustion Engine

(76) Inventors: Alexander Ketterer, Pettendorf/Adlersberg (DE); Gerd Rosel, Regensburg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/662,004

(22) PCT Filed: Aug. 4, 2005
(86) PCT No.: PCT/EP05/53853

§ 371 Date: Mar. 6, 2007

(30) Foreign Application Priority Data
Sep. 8, 2004 (DE) 10 2004 043 535.9

(51) Int. Cl. F01N 11/00; F02D 41/14; F02D 41/34

(52) U.S. Cl. 60/274

(57) ABSTRACT

The invention relates to a method which is characterized in that before an active catalyst diagnosis is carried out the mixture is dynamically trimmed for all individual catalysts using a signal of a lambda sensor common to the individual catalysts. Once the mixture is successfully trimmed, the cylinder-based forced activation is adjusted in such a manner that the individual catalysts, by virtue of the charge imprinted thereon for a threshold catalyst, exceed their remaining oxygen storage capacity to such an extent that the lambda sensor is enabled to measure the storable charge. The cylinder-based lambda signals reconstructed from the sensor signal are then used to determine specific diagnostic values for every individual catalyst.

### CROSS REFERENCE TO RELATED APPLICATIONS

This application is the US National Stage of International Application No. PCT/EP2005/053853, filed Aug. 4, 2005 and claims the benefit thereof. The International Application claims the benefits of German application No. 10 2004 043 535.9 filed Sep. 8, 2004, both of the applications are incorporated by reference herein in their entirety.

### FIELD OF INVENTION

The present invention relates to a method for diagnosing cylinder-associated individual catalytic converters of a multicylinder Otto cycle internal combustion engine.

### BACKGROUND OF THE INVENTION

In order to be able to satisfy the currently applicable on-board diagnostics (OBD) regulations, it is necessary to check the efficiency of the part of an internal combustion engine's catalytic converter system which, if its efficiency deteriorates, will cause correlating OBD limit value emissions to be exceeded. For today's usual catalytic converter configurations whereby a main catalytic converter and a common pre-catalytic converter are provided for all the cylinders, various methods for detecting the conversion rate of the catalytic converters are known, see e.g. “Handbuch Verbrennungsmotor” (Internal Combustion Engine Handbook), 2nd ed., by Richard von Basshuysen/Fred Schafer, pp. 568, 569. All these methods use the oxygen storage capacity (OSC) of the catalytic converter. DE 196 30 940 C2 discloses such an OSC-based diagnostic method in which, during a diagnostic cycle, the forced activation parameters (amplitude, period) of the air-fuel ratio (lambda) are set so as to produce a maximum oxygen charge of the catalytic converter. The oscillating signal of a lambda sensor (post-cat sensor) downstream of the catalytic converter is then used to determine a measure for the area bounded by the mean value of the sensor signal and the sensor signal. This measure is then compared with a corresponding value of a borderline catalytic converter which has been aged to the maximum permissible extent. The catalytic converter efficiency can then be determined therefrom.

### SUMMARY OF INVENTION

The diagnostic method according to the present invention relates to a catalytic converter system configuration in which the individual cylinders are each assigned an individual catalytic converter and there is possibly provided a common main catalytic converter downstream of the individual catalytic converters. The catalytic converters are each implemented as 3-way catalytic converters, the individual catalytic converters having a predefined but relatively low oxygen storage capacity. The individual catalytic converters are disposed as close as possible to the internal combustion engine and can be installed, for example, directly in the respective manifolds in order to achieve an optimally prompt “response” of the individual catalytic converters. To detect the air-fuel ratio there is provided a common lambda sensor which is disposed downstream at or after the convergence of the exhaust pipes containing the individual catalytic converters.

In this catalytic converter system there is provided cylinder-associated lambda control using cylinder-associated forced activation, by means of which a periodic variation in the form of a lambda pulse is superimposed on a stoichiometric lambda setpoint value to optimize the catalytic converter efficiency.

Already known from DE 102 06 402 C1 is a method for cylinder-selective lambda control in which the signal of a lambda sensor is cycle-resolved by a microcontroller so that the lambda signal can be assigned to the individual cylinders and individual exhaust packets of these cylinders can be detected.

The object of the present invention is to specify a method for diagnosing cylinder-associated individual catalytic converters of a homogeneously operated multicylinder Otto cycle internal combustion engine, permitting diagnostics of the conversion rate of the individual catalytic converters using the signal of a common lambda sensor disposed downstream of the individual catalytic converters.

The invention as well as advantageous embodiments of the invention are defined in the claims.

For OSC-based catalytic converter diagnostics it is important that, prior to the forced activation switchover required for the diagnostics, a defined oxygen charge of the catalytic converter is set in order to avoid breakdowns of the catalytic converter only in one direction or the other.

According to the invention it is therefore provided that, prior to active catalytic converter diagnostics, cylinder-associated lambda signals (Vr) are reconstructed from the signal of the lambda sensor (LS1) on a cycle-resolved basis and, using said reconstructed lambda signals (Vr), cylinder-associated trimming control is performed for each of the individual catalytic converters (K1-K4), signal deviations (AVr) from a mean reference value (Vref) in the catalytic converter window being used as the control deviation.

According to a first aspect of the invention, if this dynamic mixture trimming is unable to eliminate deviations of the reconstructed cylinder-associated lambda signal both in the over- and under-stoichiometric direction for the individual cylinders, i.e. if no stable average air-fuel ratio can be achieved, it is inferred that an individual catalytic converter is defective. The defect may be caused by a significant reduction in oxygen storage capacity due to ageing or also by severe mechanical damage or destruction. Active diagnostics are then no longer required for the individual catalytic converter in question.

By means of the cylinder-associated mixture trimming described, it is possible to differentiate between lambda deviations caused by mixture tolerances and an actually reduced oxygen storage capacity of the individual catalytic converter and associated signal reactions over the entire measuring range of the downstream lambda sensor. An impermissible defect of the individual catalytic converters can, as described, already be established by mixture trimming without the need for separate active catalytic converter diagnostics.

Another advantage of the described cylinder-associated mixture trimming is that, due to the rapid detection and cycle-related filtering of the signal of the downstream lambda sensor, conventional OSC-based diagnostic methods can be used, as will be explained below. In particular, by means of the cycle-resolved analysis of the lambda sensor signal, a standard algorithm for conventional diagnostic methods can be used to determine the catalytic converter efficiency by means of OSC/emission correlation, as will likewise be explained below.

According to a second aspect of the invention, if successful dynamic mixture trimming is possible and has been carried out, active catalytic converter diagnostics are performed by setting the forced activation parameters during a diagnostic cycle in such a way that the thereby caused oxygen charge of the individual catalytic converters is at least so high that, in the case of an oxygen storage capacity of the relevant individual catalytic converter corresponding to that of a borderline catalytic converter, deviations of the reconstructed cylinder-associated lambda signals occur in both the over- and under-stoichiometric direction, and deviations of the reconstructed cylinder-associated lambda signals occurring during the diagnostic cycle are used for OSC-based diagnostics of the individual catalytic converters.

The OSC-based diagnostic methods known from the prior art, as disclosed e.g. in the abovementioned DE 196 30 940 C2, can be used here to determine the conversion rate of the individual catalytic converters. This makes it possible for a characteristic value for OSC-based catalytic converter diagnostics to be obtained from the deviations of the reconstructed cylinder-associated lambda signals of each individual catalytic converter during the diagnostic cycle, said value then being compared with a specific borderline catalytic converter value stored in an engine map in order to determine a specific diagnostic value representing the catalytic converter efficiency for each individual catalytic converter.

If during active catalytic converter diagnostics the need for mixture trimming is detected for an individual catalytic converter, the loading of the relevant individual catalytic converter has not attained the reference value required for diagnostics. The result of the active catalytic converter diagnostics is then discarded, and active catalytic converter diagnostics are then restarted after successful mixture re-trimming.

Analysis of the lambda sensor signal for active catalytic converter diagnostics is preferably not performed until after a stabilization phase in which the forced activation parameters are changed over to the values required for diagnostics and in which the lambda sensor signal can stabilize. This reduces scattering of the lambda sensor signal from previous disturbances due to non-steady-state processes, thereby also eliminating other destabilizing factors such as the dwell time between fuel injection and lambda sensor.

The advantage of the method for active catalytic converter diagnostics is that, due to the switching-over of the forced activation parameters, the small individual catalytic converters with slight OSC differences between a permissible and an impermissible value in respect of the emission limit value can be diagnosed. Due to the monitored oxygen charge of the individual catalytic converters during a stabilization phase, tolerances for diagnosing the small OSC differences of the relevant individual catalytic converters can be minimized.

In order to allow optimum emission reduction even for individual catalytic converters with reduced efficiency and also the possibility of dynamic mixture trimming for the individual catalytic converters, according to a third aspect of the invention it is provided that the mixture control and forced activation parameters for normal operation of the internal combustion engine are adapted to the diagnostic values for the individual catalytic converters determined during active catalytic converter diagnostics in order to adapt the oxygen charge of the individual catalytic converters to their ageing state. The forced activation parameters for active catalytic converter diagnostics are also beneficially adapted to the diagnostic values for the individual catalytic converters determined during previous active catalytic converter diagnostics in order to avoid an unnecessarily high oxygen charge of the individual catalytic converters.

According to the third aspect of the present invention, the oxygen charge of the individual catalytic converters can therefore be adapted to their ageing state. Adaptively matching the corresponding control parameters therefore reduces the increase in pollutant emissions during normal operation and also during active catalytic converter diagnostics over the service life.

### BRIEF DESCRIPTION OF THE DRAWINGS

Further details of the method according to the invention will now be explained with reference to the accompanying drawings in which:

FIG. 1 is a schematic diagram illustrating a catalytic converter system configuration for exhaust gas treatment on a 4-cylinder internal combustion engine;

FIG. 2 shows a forced activation lambda pulse for normal operation of the internal combustion engine;

FIG. 3 shows a forced activation lambda pulse for active catalytic converter diagnostics;

FIG. 4 is a diagram showing a lambda pulse for active catalytic converter diagnostics and three different waveforms of a reconstructed cylinder-associated lambda signal for a cylinder.

### DETAILED DESCRIPTION OF INVENTION

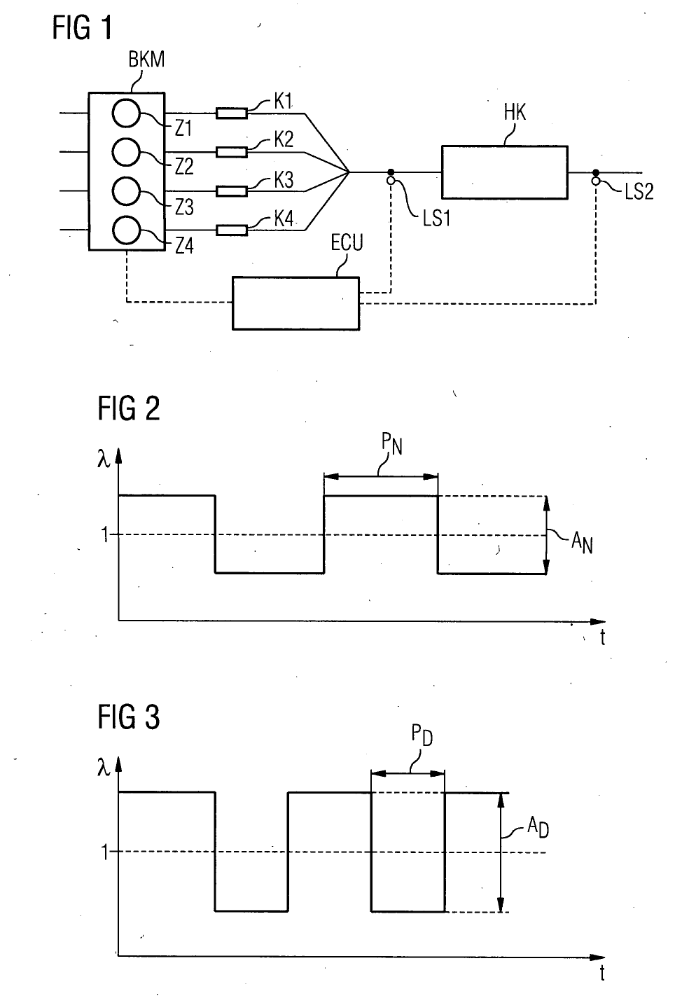

FIG. 1 schematically illustrates an example of a catalytic converter system configuration for a 4-cylinder Otto cycle internal combustion engine BKM having four cylinders Z1-Z4, cylinder-associated individual catalytic converters K1-K4 and possibly a main catalytic converter HK disposed downstream of the individual catalytic converters K1-K4. The individual catalytic converters and the main catalytic converter are implemented as 3-way catalytic converters, the individual catalytic converters having a predefined relatively small oxygen storage capacity (OSC).

Between the individual catalytic converters K1-K4 and the main catalytic converter HK there is generally disposed in the common exhaust tract a lambda sensor LS1 whose signal is fed to an electronic control unit ECU. The lambda sensor LS1 can be implemented for the method described below for diagnosing the conversion rate of the individual catalytic converters K1-K4 both as a continuous sensor and as a binary sensor (Nernst sensor). In addition, the main catalytic converter HK is followed by another lambda sensor LS2 which, however, is not required for the diagnostic method.

The electronic control unit ECU performs mixture control in the form of cylinder-associated lambda control using cylinder-associated forced activation. As is generally known, by means of the forced activation a periodic variation in the form of a lambda pulse is superimposed on a stoichiometric lambda setpoint value to optimize the catalytic converter efficiency.

Because of their small oxygen storage capacity and the forced activation required, operation of the individual catalytic converters K1 to K4 results in a residual oxygen concentration typical for this system configuration and which can be detected by the downstream lambda sensor LS1. With the diagnostic method now to be described, the efficiency of the individual catalytic converters K1-K4 can be deduced by analyzing the signal response of the lambda sensor LS1.

According to the first aspect of the present invention, dynamic mixture trimming is performed for all the cylinders Z1-Z4 prior to catalytic converter diagnostics. This is necessary, as a defined average oxygen charge of the individual catalytic converter which is required for diagnostics must be set prior to the start of diagnostics. Briefly, this cylinder-associated dynamic mixture trimming for the individual catalytic converters K1-K4 is performed as follows.

As already mentioned, there is provided for the individual catalytic converters K1-K4 a cylinder-associated forced activation which superimposes a periodically varying lambda pulse of amplitude A and period P on a stoichiometric average lambda (λ=1) (A_{N} and P_{N} for normal operation, see FIG. 2). The cylinder-associated forced activation of the individual catalytic converters K1-K4 is adapted to their oxygen storage capacity in such a way that, at the end of each lean mixture half-cycle, a predefined target oxygen charge of the individual catalytic converters is achieved.

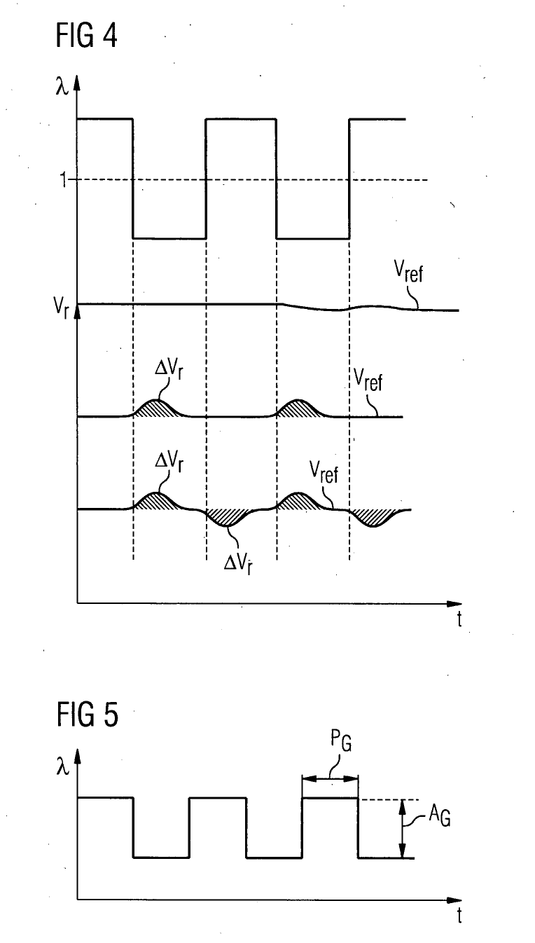

Signal detection for mixture trimming takes place in a cycle-resolved manner from the model variables of the cylinder-selective lambda control. Correspondingly, cylinder-associated lambda signals are reconstructed on a cycle-resolved basis from the signal of the lambda sensor LS1 so that, for each cylinder with associated individual catalytic converter, a corresponding cylinder-associated lambda signal Vr is produced, as shown in the lower part of FIG. 4 for one of the cylinders Z1-Z4.

From the constant responses of the cylinder-associated lambda signals Vr over all the cylinders Z1-Z4, a mean reference value Vref for the oxygen charge of the individual catalytic converters is obtained which constitutes the measure for the catalytic converter window. The constant signal responses are produced on the basis of the oxygen storage capacity of the individual catalytic converters. If deviations ΔVr of the cylinder-associated lambda signals Vr from the reference value Vref occur, these are due to rich or lean mixture faults. The signal deviations trigger a trimming reaction of a corresponding trimming control in order to eliminate these signal deviations.

To make this clear, the reader is referred to the lower part of FIG. 4. The topmost curve of the reconstructed cylinder-associated lambda signal Vr has a constant waveform, corresponding to the mean reference value Vref. The fact that no signal deviations are present means that no rich or lean mixture breakdowns are being produced in the individual catalytic converter of the relevant cylinder so that there is no need for trimming. From this, it may be inferred that the relevant individual catalytic converter has an adequate oxygen storage capacity and therefore a satisfactory conversion rate; the individual catalytic converter is therefore OK.

The reconstructed cylinder-associated lambda signal Vr in the middle shows signal deviations ΔVr in one direction only, namely in the over-stoichiometric (i.e. lean mixture) direction. If these signal deviations ΔVr can be eliminated by the above-described trimming control, it can likewise be inferred that the relevant individual catalytic converter is OK.

On the other hand, if signal deviations ΔVr occur in both directions, as shown by the lower reconstructed cylinder-associated signal in FIG. 4, these signal deviations can no longer be eliminated by the trimming control described. This means that the relevant individual catalytic converter shows both rich and lean mixture breakdowns, as its oxygen storage capacity has an impermissibly low value. Its conversion rate is therefore so poor that the limit value emissions specified by the requirements of the on-board diagnostics (OBD) are being exceeded.

The relevant individual catalytic converter is therefore deemed to be defective, without the need for further active catalytic converter diagnostics.

According to the second aspect of the present invention, active catalytic converter diagnostics are performed during a diagnostic cycle if successful mixture trimming is possible and has been carried out, as explained above. OSC-based diagnostic methods can be used for active catalytic converter diagnostics, as disclosed in the already mentioned DE 196 30 940 C2.

At the start of diagnostics, the forced activation parameters A_{D}, P_{D} are set so as to maximize the oxygen charge of the catalytic converter, the maximum oxygen charge of the relevant individual catalytic converter being selected such that, due to the impressed oxygen charge for a borderline catalytic converter, the individual catalytic converter exceeds the remaining residual oxygen storage capacity in such a way that the downstream lambda sensor LS1 can measure the unstorable oxygen content of the exhaust gas. Generally, the switching-over of the forced activation takes place in such a way that the amplitude A of the forced activation is increased accordingly, as shown by way of example in FIG. 3.

To perform active catalytic converter diagnostics, reconstructed cylinder-associated lambda signals Vr are in turn formed from the signal of the lambda sensor LS1 on a cycle-resolved basis as illustrated in the lower part of FIG. 4. If the reconstructed cylinder-associated signal Vr has a constant waveform and therefore no signal deviations AVr occur, as illustrated by the upper curve for Vr in FIG. 4, it may be inferred that the catalytic converter is OK.

On the other hand, if signal deviations ΔVr occur in both directions (see the lower curve in FIG. 4), the magnitude of these signal deviations depends on the efficiency of the relevant individual catalytic converter. By means of a conventional OSC-based diagnostic method, as disclosed in DE 196 30 940 C2, the amount of oxygen charge of the individual catalytic converter to be diagnosed can be calculated. Briefly, the procedure here is such that a measure for the area bounded by the mean reference value Vref and the signal deviations ΔVr during the diagnostic cycle is determined. This measure is then compared with an engine map reference value of a borderline catalytic converter whose oxygen storage capacity is “on the limit”. This comparison then makes it possible to determine whether and how severely the efficiency of the relevant individual catalytic converter has diminished. In this way a specific catalytic converter diagnostic value can be determined for each individual catalytic converter.

If during active diagnostics it is established that a need exists for mixture trimming for the relevant individual catalytic converter (see the middle curve for the reconstructed cylinder-associated lambda signal Vr in FIG. 4), the result of the active catalytic converter diagnostics is rejected. Trimming control is then repeated. If this has resulted in the elimination of the corresponding signal deviations AVr, active catalytic converter diagnostics are restarted.

It is advisable not to perform signal analysis for active catalytic converter diagnostics until after a stabilization phase in which the forced activation parameters A_{D}, P_{D} have been changed over to the values required for the diagnostics and in which the signal of the lambda sensor LS1 can stabilize. This enables scattering of the signal of the lambda sensor LS1 from previous disturbances due to non-steady state processes to be reduced. It also enables other processes affecting the diagnostic result, such as the dwell time between fuel injection and signal generation to be taken into account. The procedure here is preferably such that the changeover of the forced activation parameters A_{D}, P_{D} takes place gradually, e.g. via a “stabilization ramp”.

According to a third aspect of the present invention, the parameters for mixture control and of the associated forced activation for normal operation of the internal combustion engine are adapted to the diagnostic value determined during previous active catalytic converter diagnostics in order to adapt the oxygen charge of individual catalytic converters K1-K4 to the ageing state, thereby enabling optimum emission reduction to be achieved even by individual catalytic converters with reduced efficiency. Moreover, successful cylinder-associated mixture trimming can be performed even for such efficiency-reduced individual catalytic converters. A correspondingly adapted forced activation with reduced amplitude A_{G} and reduced period P_{G} is shown by way of example in FIG. 5. The modification of the forced activation parameters can be determined by factors e.g. as follows:
P_{G}=P_{N}×f (catalytic converter efficiency)
A_{G}=A_{N}×f (catalytic converter efficiency),
where A_{N}, P_{N} are the parameters for normal operation and A_{G}, P_{G} the parameters for an aged catalytic converter.

A corresponding “ageing adaptation” can also take place for the active catalytic converter diagnostics. In this case also it is advisable to adapt the oxygen charge, impressed by the forced activation, of the individual catalytic converter to be diagnosed over the lifetime of the catalytic converter system to the catalytic converter efficiency in order to avoid an unnecessarily high oxygen charge during the diagnostic cycle.

The ageing adaptation of the forced activation parameters is preferably performed jointly and in the same way for all the cylinders of a cylinder bank in order to prevent uneven torque contributions of the relevant cylinders due to different oxygen charges of the individual catalytic converters.

If due to ageing adaptation the individual catalytic converters' oxygen charge impressed by the forced activation is reduced to the extent that forced activation can also be deactivated, as the oxygen storage capacity of the relevant individual catalytic converter has become too small, the relevant individual catalytic converter is deemed to be defective.

1.-9. (canceled)

10. A method for diagnosing cylinder-associated individual catalytic converters of a homogeneously operated multi-cylinder Otto cycle internal combustion engine having cylinder-associated lambda control with cylinder-associated forced activation, comprising:
providing a convergence of a plurality of exhaust gas pipes, each pipe containing an individual catalytic converter, the convergence arranged downstream of the individual catalytic converters, wherein the individual catalytic converters are 3-way catalytic converters and each having a predefined oxygen storage capacity;
arranging a common lambda sensor at or after the convergence of the exhaust gas pipes containing the individual catalytic converters;
reconstructing a plurality of cylinder-associated lambda signals from a signal of the lambda sensor on a cycle-resolved basis prior to an active catalytic converter diagnostics;
performing cylinder-associated trimming control with the aid of the reconstructed lambda signals for each of the individual catalytic converters, where signal deviations from a mean reference value lying within a catalytic converter window is used as a control deviation; and
determining an individual catalytic converter to be defective if successful mixture trimming is not possible because signal deviations in both the over- and under-stoichiometric direction cannot be eliminated by the trimming control.

11. The method as claimed in claim 10, wherein after dynamic mixture trimming has been performed, performing active catalytic converter diagnostics by:
setting the forced activation parameters during a diagnostic cycle such that the oxygen charge of the individual catalytic converters is at least high enough that if the oxygen storage capacity of the relevant individual catalytic converter corresponds to that of a borderline catalytic converter, signal deviations of the reconstructed cylinder-associated lambda signals occur in both the over- and under-stoichiometric direction, and
using the signal deviations of the reconstructed cylinder-associated lambda signals occurring during the diagnostic cycle for OSC-based diagnostics of the individual catalytic converters.

12. The method as claimed in claim 11, wherein during the diagnostic cycle, a characteristic value for OSC-based catalytic converter diagnostics is obtained from the signal deviations of the reconstructed cylinder-associated lambda signals of each individual catalytic converter, the value then being compared with a specific borderline catalytic converter value stored in an engine map in order to determine for each individual catalytic converter a specific diagnostic value representing the catalytic converter efficiency.

13. The method as claimed in claim 11, wherein if, during active catalytic converter diagnostics, the need for mixture trimming for an individual catalytic converter is identified, the result of the active catalytic converter diagnostics is discarded and the active catalytic converter diagnostics are restarted after successful mixture re-trimming.

14. The method as claimed in claim 11, wherein an analysis of the lambda sensor signal for active catalytic converter diagnostics is not performed until after a stabilization phase in which the forced activation parameters are changed over to values required for catalytic converter diagnostics and where the signal of the lambda sensor stabilizes.

15. The method as claimed in claim 14, wherein the changeover of the forced activation parameters for active catalytic converter diagnostics takes place gradually.

16. The method as claimed in claim 12, wherein the mixture control and forced activation parameters for normal operation of the internal combustion engine are adapted to the diagnostic values for the individual catalytic converters determined during active catalytic converter diagnostics in order to adapt the oxygen charge of the individual catalytic converters to a respective state of ageing.

17. The method as claimed in claim 12, wherein the forced activation parameters for the active catalytic converter diagnostics are adapted to the diagnostic values for the individual catalytic converters determined during previous active catalytic converter diagnostics in order to avoid an unnecessarily high oxygen charge of the individual catalytic converters.

18. The method as claimed in claim 16, wherein the parameters are adapted jointly for all the cylinders of a cylinder bank of the engine.

19. The method as claimed in claim 17, wherein the parameters are adapted jointly for all the cylinders of a cylinder bank of the engine.

20. A method for diagnosing proper operation of a mult-cylinder Otto cycle internal combustion engine having cylinder-associated lambda control with cylinder-associated forced activation, comprising:
providing an individual exhaust pipe for each cylinder of the multi-cylinder engine, wherein each pipe contains an individual 3-way catalytic converter having a predefined oxygen storage capacity;
providing a pipe collector that collects the individual exhaust pipes into a single exhaust pipe;
arranging a common lambda sensor at least as close to the individual catalytic converters as the collector;
reconstructing a plurality of cylinder-associated lambda signals from a signal of the lambda sensor on a cycle-resolved basis prior to an active catalytic converter diagnostics;
performing cylinder-associated trimming control with the aid of the reconstructed lambda signals for each of the individual catalytic converters, where signal deviations from a mean reference value lying within a catalytic converter window is used as a control deviation; and
determining an individual catalytic converter to be defective if successful mixture trimming is not possible because signal deviations in both the over- and under-stoichiometric direction cannot be eliminated by the trimming control.
